(19) United States
(12) Patent Application Publication
(10) Pub. No.: US 2026/0109327 A1
(43) Pub. Date: Apr. 23, 2026

(54) Intelligent Car Washing Robot

(71) Applicant: SHAANXI ANGCHEJUN ELECTRONIC TECHNOLOGY CO., LTD, Xi'an (CN)

(72) Inventor: Jingwei ZHANG, Xi'an (CN)

(21) Appl. No.: 19/117,021

(22) PCT Filed: Jul. 28, 2023
(86) PCT No.: PCT/CN2023/109787

§ 371 Date: Oct. 19, 2025

(30) Foreign Application Priority Data
Nov. 17, 2022 (CN) 202211459744.0

(51) Int. Cl. B60S 3/04

(52) U.S. Cl. CPC B60S 3/04

(57) ABSTRACT

An intelligent car washing robot configured to recognize dirt on a car to be washed (1) in a three-axis linkage manner and accurately wash the dirt in a mobile line scanning manner. The intelligent car washing robot includes: a main body (2), located at one side of a front passenger door of the car to be washed (1); a traveling device (4), arranged on the main body (2) and detachably connected to a bottom surface of the main body (2); a profiling arm (3), one end of which is fixed to one side wall of the main body (2); mobile devices (6), respectively arranged on an upper part and a lower part of the profiling arm (3), and in rolling connection to the profiling arm (3); and a cleaning device (5), located between the profiling arm (3) and the car to be washed (1).

### CROSS-REFERENCE TO RELATED APPLICATION

This patent application is a national stage application of International Patent Application No. PCT/CN2023/109787, filed on Jul. 28, 2023, which claims the benefit and priority of Chinese Patent Application No. 202211459744.0, filed with the China National Intellectual Property Administration on Nov. 17, 2022, the disclosure of which is incorporated by reference herein in its entirety as part of the present application.

### TECHNICAL FIELD

The present disclosure relates to the technical field of automatic car washing machines, and in particular, to an intelligent car washing robot.

### BACKGROUND

With rapid development of high technology, a car washing industry has rapidly developed from semi-automatic car washing to intelligent car washing, which completely replaces a process of manual car washing.

Chinese patent application document CN113997906A discloses an intelligent automatic car washing machine. The intelligent automatic car washing machine provided in this solution includes a supplement connection seat and a car washing robot body. The car washing robot body includes a base, a moving mechanism, a lithium battery, an automatic control module, a first water tank, a first cleaning solution storage tank, a water spraying pipe, a cleaning solution spraying pipe, a support, a first liquid pump, a second liquid pump, and an air heater. An achieved technical effect is that a car washing robot body adopts a non-contact car washing solution, an L-shaped support is designed to connect the water spraying pipe and an injection pipe, the car washing robot body moves around a car to realize full coverage of cleaning, and a brush roller does not need to be in contact with a car body in a whole car washing process. On one hand, equipment costs and equipment maintenance costs are reduced, steps of periodically cleaning, maintaining, and replacing the brush roller are omitted, a complex mechanical structure for controlling the brush roller to rotate is not required, a service life is longer, and a risk that mud and sand adhering to the brush roller scratch car paint can also be avoided, thereby reducing the equipment costs, and achieving high-efficiency high-quality car washing.

Combining FIG. 1 and FIG. 2 in the foregoing application document, it is to be learned that a technical solution of this application document is that the L-shaped support is designed to connect the water spraying pipe and the injection pipe. Essentially, a plurality of water spraying pipes and injection pipes are arranged on the L-shaped support, and the water spraying pipes and the injection pipes at different positions spray water to different positions of a car, and dirt is washed away relying on a washing effect of the water, thereby achieving a purpose of washing the car. However, each water spraying pipe and injection pipe can only spray water to areas respectively corresponding thereto. It is a single directional cleaning manner in a mobile cleaning process. Moreover, it can be learned from drawings that there is a distance between adjacent water spraying pipes. In this away, in a water spraying process, the areas corresponding to the water spraying pipes and the injection pipes are cleaned, but dirt in an edge area cannot be washed thoroughly. Especially when encountering a lot of dirt and located in a critical area between two adjacent water spraying pipelines or in a dead corner of a rear of the car, the single directional cleaning manner in the above technology cannot achieve a purpose of thoroughly cleaning the dirt. Unwashed dirt needs to be cleaned manually when necessary. Therefore, car cleaning efficiency is low, and intelligent automation level is low.

### SUMMARY

To solve a technical problem of low car cleaning efficiency caused by the foregoing single directional cleaning manner, the present disclosure provides an intelligent car washing robot, which has a cleaning device to perform, in a process of driving a main body and a profiling arm to move a circle around a car to be washed, scanning cleaning on a whole body of the car.

To achieve the foregoing objective, the present disclosure is implemented through the following technical solutions:
an intelligent car washing robot, configured to perform mobile line scanning cleaning on dirt on a car to be washed in a three-axis linkage manner, including:
a main body, located on one side of a front passenger door of the car to be washed, and having a preset distance from the car to be washed;
a traveling device, arranged on the main body, detachably connected to a bottom surface of the main body, and configured to drive the main body to travel from an initial position to one side of the front passenger door in a Y-axis direction according to a preset route, where the Y-axis direction is a forward direction of the traveling device;
a profiling arm, where one end of the profiling arm is fixed to one side wall of the main body and faces the car to be washed, the other end is located above the car to be washed, the traveling device is configured to drive the main body to move a circle around the car to be washed clockwise from one side of the front passenger door in the Y-axis direction, to drive the profiling arm to move around the main body;
mobile devices, respectively arranged on an upper part and a lower part of the profiling arm, and in rolling connection to the profiling arm, where the mobile devices are configured to respectively move reciprocally on the profiling arm in a Z-axis direction and an X-axis direction, the Z-axis direction is a vertical direction of the profiling arm relative to the car to be washed, and the X-axis direction is a horizontal direction of the profiling arm relative to the car to be washed; and
a cleaning device, located between the profiling arm and the car to be washed, detachably connected to the mobile devices, and configured to follow movement of the mobile devices to clean dirt at any position on the car to be washed in a reciprocating line scanning manner.

Compared with a conventional technology, the present disclosure has the following advantages: after the traveling device 4 moves from the initial position to vicinity of the front passenger door of the car to be washed 1 in the Y-axis direction of the traveling device 4, first, following movement of the mobile devices 6 respectively in the Z-axis direction and the X-axis direction on the profiling arm 3, the cleaning device 5 performs, from one side of the front passenger door of the car to be washed 1, continuous scanning cleaning from top to bottom from a window on the front passenger door to a lower part of the front passenger door in the Z-axis direction, and simultaneously cleans the dirt on a car roof in the X-axis direction. Then, the traveling device 4 continues to drive the main body 2 to clockwise move a circle around the car body in the Y-axis according to the preset route, to drive the cleaning device 5 to gradually perform scanning washing around the car body. In an overall cleaning process, a three-axis linkage cleaning manner in the X-axis direction, the Y-axis direction, and the Z-axis direction is achieved, clean water can be completely sprayed to the whole body and tires of the car to be washed 1, and a problem of low car washing efficiency caused by incomplete cleaning at dead corners and uncleaned dirt in critical areas is directly avoided.

As a further optimization, the main body is provided with:
a control module, which is connected to and controls each of the cleaning device and the traveling device; and
a server, where a data receiving end of the server is in communication connection with a mobile terminal, a data output end is in data connection with the control module, in a network environment, the server is configured to receive request information and confirmation information sent by the mobile terminal, the control module is configured to obtain the request information and the confirmation information, and output a control signal to the cleaning device to control the cleaning device to spray water to wash the car to be washed, and the control module is configured to send a straight signal or a steering signal to the traveling device to control the traveling device to travel in a straight line or to steer.

By adopting the foregoing technical solution, the server obtains the request information and the confirmation information from the mobile terminal in the network environment, and transmits the request information to the control module. The control module operates according to a preset program to obtain a control signal, and sends a signal to the cleaning device to control the cleaning device to move reciprocally on the profiling arm, to intelligently control the cleaning device to clean the car to be washed. When it is determined that the intelligent car washing robot needs to move on one side of the car to be washed, the control module sends a straight signal or a steering signal to control the traveling device to travel in a straight line or to steer, thereby moving a circle around the car to be washed.

As a further optimization, the main body includes:
a support, mounted on a top surface of the traveling device, where one side wall of the support is fixedly connected to the profiling arm;
a first bottom plate, horizontally and fixedly connected to the support, and configured to carry the server;
a second bottom plate, opposite to a position of the first bottom plate, fixedly connected to the support, and configured to carry the control module; and
a third bottom plate, horizontally and fixedly connected to an inner wall of the support, having a distance from both the first bottom plate and the second bottom plate, and configured to carry a water tank.

By adopting the foregoing technical solution, a complete intelligent car washing structure is formed through the support, the first bottom plate, the second bottom plate, and the third bottom plate, which provides a necessary hardware carrying platform for intelligent car washing.

As a further optimization, the traveling device includes:
a base;
a steering wheel, arranged on one side of the base, rotatably connected to the base, and configured to change a movement direction through rotation;
a steering motor, detachably connected to the base, and on the same side of the steering wheel;
a driving wheel, arranged on the other side of the base, opposite to a position of the steering motor, and connected to a working end of the steering motor, where the steering motor is configured to drive the driving wheel to rotate; and
a driven wheel, rotatably connected to the other side of the base, and meshing the driving wheel, where one side wall of the driven wheel is connected to the steering wheel, the other side wall is rotatably connected to a bottom surface of the main body, the driving wheel is configured to drive the driven wheel to rotate through rotation, and the driven wheel is configured to drive the steering wheel to rotate, thereby changing the movement direction of the main body.

By adopting the foregoing technical solution, the steering motor drives, after rotating, the driving wheel to rotate. In a process that the driving wheel rotates for a round, the driven wheel is driven by the driving wheel to rotate a preset arc, and the driven wheel drives the steering wheel to rotate a preset angle, so that the movement direction of the main body is changed by changing a rotation direction to achieve a process of clockwise moving a circle around the car body from the front passenger door.

As a further optimization, the profiling arm includes:
an upper arm assembly, located at an upper horizontal position relative to the car to be washed, and configured to cooperate with the cleaning device to clean dirt on an upper surface of the car to be washed;
a lower arm assembly, located on a vertical side relative to the car to be washed, fixedly connected to the upper arm assembly, and configured to cooperate with the cleaning device to clean the dirt on a side body of the car to be washed; and
track assemblies, respectively laid on the upper arm assembly and the lower arm assembly, screwed to the upper arm assembly and the lower arm assembly, and configured to carry the mobile devices, to enable the mobile devices to move on the track assemblies.

By adopting the foregoing technical solution, during cleaning, the upper arm assembly and the lower arm assembly separately and simultaneously move on the track assemblies reciprocally, so that a side body of the car to be washed is cleaned through the lower arm assembly while cleaning the upper surface of the car to be washed, and different areas of the car to be washed are cleaned simultaneously, thereby shortening cleaning time, and improving cleaning efficiency.

As a further optimization, the upper arm assembly includes:
a cross arm, located above the car to be washed, and parallel to a top surface of the car to be washed; and
a bent arm, arranged at an end part of the cross arm, and fixedly connected to the cross arm. The mobile devices are configured to move reciprocally between the cross arm and the bent arm.

By adopting the foregoing technical solution, the cleaning device follows reciprocating movement of the mobile devices to clean the top surface or the upper surface of the car to be washed.

As a further optimization, the lower arm assembly includes:
an inclined arm, where one end of the inclined arm is fixedly connected to the other end of the bent arm, and is parallel to an upper body of the car to be washed; and
a vertical arm, where one end of the vertical arm is fixedly connected to the other end of the inclined arm, and is parallel to a lower body of the car to be washed.

By adopting the foregoing technical solution, when the cleaning device follows the mobile devices to move to the inclined arm, car windows, front windshield, and rear windshield are cleaned; and when the cleaning device moves to the vertical arm, car doors, wheels, a rear bumper of the car, a front bumper of the car, and dirt at relatively low positions can be cleaned, thereby achieving a purpose of cleaning the whole car in a continuous scanning manner.

As a further optimization, the track assembly includes:
chain slots, respectively provided in the cross arm, the bent arm, the inclined arm, and the vertical arm, and fitting the cross arm, the bent arm, the inclined arm, and the vertical arm; and
a chain, laid on the chain slots, where a bottom surface of the chain is fixedly connected to the chain slots, a surface meshes the mobile devices, and the chain is configured to cooperate with reciprocating movement of the mobile devices.

By adopting the foregoing technical solution, the cleaning device is driven to clean the dirt on the car to be washed along the chains.

As a further optimization, the mobile device includes:
a sliding plate, wherein one side wall of the sliding plate is in contact with the profiling arm, and the sliding plate is configured to slide reciprocally on the profiling arm;
a first roller, fixed to one side wall of the sliding plate, in contact with an upper surface of the profiling arm, and configured to slide on an upper surface of the profiling arm;
a second roller, fixedly connected to the sliding plate, on the same side as the first roller, in contact with a lower surface of the profiling arm, and configured to move reciprocally along the lower surface of the profiling arm;
a mobile motor;
a transmission, connected to a working end of the mobile motor, wherein a bottom surface of the transmission is screwed to the cleaning device; and
a rotating shaft, where a middle part of the rotating shaft is connected to the transmission, an end part is rotatably connected to the profiling arm, and the transmission is configured to drive the rotating shaft to move reciprocally on the profiling arm by changing a rotation direction output by the mobile motor, to drive the cleaning device to move along the profiling arm.

By adopting the foregoing technical solution, the mobile motor indirectly drives the cleaning device to move reciprocally on the profiling arm, so as to achieve a purpose of cleaning the dirt on the car to be washed.

As a further optimization, the cleaning device includes:
a linear module, mounted on the mobile device, configured to follow the mobile device to move reciprocally on the upper part and the lower part of the profiling arm;
a chute, provided in the linear module;
a sliding block, arranged on a bottom surface of the linear module, where a side wall of the sliding block is in sliding connection with the chute;
a line scanning motor, mounted at an end part of the linear module, where a working end of the line scanning motor is connected to the sliding block, and is configured to drive the sliding block to perform linear reciprocating movement in the chute;
a water spraying pipe, mounted outside the linear module, where an end part of the water spraying pipe penetrates through the sliding block, and is configured to follow the sliding block to move; and
a spray nozzle, screwed to the water spraying pipe, and configured to spray clean water in the water spraying pipe to the car to be washed, to clean the dirt at any position of the car body of the car to be washed.

By adopting the foregoing technical solution, pressurized clean water flow is sprayed, through the water spraying pipe, from the spray nozzle to the car to be washed, the sliding block is driven by the line scanning motor to move reciprocally on the chute to drive the water spraying pipe to perform linear scanning movement, and the spray nozzle, along with the water spraying pipe, injects clean water onto the car to be washed, thereby achieving a purpose of thoroughly removing the dirt at any position of the car body.

### BRIEF DESCRIPTION OF THE DRAWINGS

FIG. 1 is a schematic structural diagram of this embodiment.

FIG. 2 is a schematic structural diagram of a traveling device and a main body in this embodiment.

FIG. 3 is a schematic structural diagram of a profiling arm in this embodiment.

FIG. 4 is a schematic structural diagram of an upper arm assembly and a lower arm assembly in this embodiment.

FIG. 5 is a schematic structural diagram of a mobile device in this embodiment.

FIG. 6 is a schematic functional module of a functional module of this embodiment.

FIG. 7 is a schematic structural diagram of a cleaning device in this embodiment.

FIG. 8 is a schematic structural diagram of a control module and a server in this embodiment.

Reference signs in the drawings: 1—car to be washed; 2—main body; 20—support; 21—first bottom plate; 22—second bottom plate; 23—third bottom plate; 3—profiling arm; 31—upper arm assembly; 311—cross arm; 312—bent arm; 32—lower arm assembly; 321—inclined arm; 322—vertical arm; 33—track assembly; 331—chain slot; 332—chain; 4—traveling device; 40—base; 41—power drive wheel; 42—steering motor; 43—steering driving wheel; 44—steering driven wheel; 5—cleaning device; 51—linear module; 52—water spraying pipe; 53—spray nozzle; 54—line scanning motor; 55—sliding block; 56—chute; 6—mobile device; 61—first roller; 62—fixing piece; 63—sliding plate; 64—second roller; 65—mobile motor; 66—transmission; 67—rotating shaft; 7—control module; and 8—server.

### DETAILED DESCRIPTION OF THE EMBODIMENTS

In a conventional technology, Chinese patent application No. CN202111233406.0 discloses an intelligent automatic car washing machine. The intelligent automatic car washing machine provided in this solution includes a supplement connection seat and a car washing robot body. The car washing robot body includes a base, a moving mechanism, a lithium battery, an automatic control module, a first water tank, a first cleaning solution storage tank, a water spraying pipe, a cleaning solution spraying pipe, a support, a first liquid pump, a second liquid pump, and an air heater. An achieved technical effect is that a car washing robot body adopts a non-contact car washing solution, an L-shaped support is designed to connect the water spraying pipe and an injection pipe, the car washing robot body moves around a car to realize full coverage of cleaning, and a brush roller does not need to be in contact with a car body in a whole car washing process. On one hand, equipment costs and equipment maintenance costs are reduced, steps of periodically cleaning, maintaining, and replacing the brush roller are omitted, a complex mechanical structure for controlling the brush roller to rotate is not required, a service life is longer, and a risk that mud and sand adhering to the brush roller scratch car paint can also be avoided, thereby reducing the equipment costs, and achieving high-efficiency high-quality car washing.

It is to be learned that this technology is that the L-shaped support is designed to connect the water spraying pipe and the injection pipe. Essentially, a plurality of water spraying pipes and injection pipes are arranged on the L-shaped support, and the water spraying pipes and the injection pipes at different positions spray water to different positions of a car, and dirt is washed away relying on a washing effect of the water, thereby achieving a purpose of washing the car. However, each water spraying pipe and injection pipe can only spray water to areas respectively corresponding thereto. It is a single directional cleaning manner in a mobile cleaning process. Moreover, it can be learned from drawings that there is a distance between adjacent water spraying pipes. In this away, in a water spraying process, the areas corresponding to the water spraying pipes and the injection pipes are cleaned, but dirt in an edge area cannot be washed thoroughly. Especially when encountering a lot of dirt and located in a critical area between two adjacent water spraying pipelines or in a dead corner of a rear of the car, the single directional cleaning manner in the above technology cannot achieve a purpose of thoroughly cleaning the dirt. Unwashed dirt needs to be cleaned manually when necessary. Therefore, car cleaning efficiency is low, and intelligent automation level is low.

For the foregoing technical problem, the present disclosure performs following design concept to change the foregoing single fixed car washing manner, pressurized clean water can be sprayed to the dirt adhered to at any position of a car body to wash the dirt with the clean water at a high pressure, thereby achieving thorough cleaning of the car to be washed, and improving cleaning efficiency.

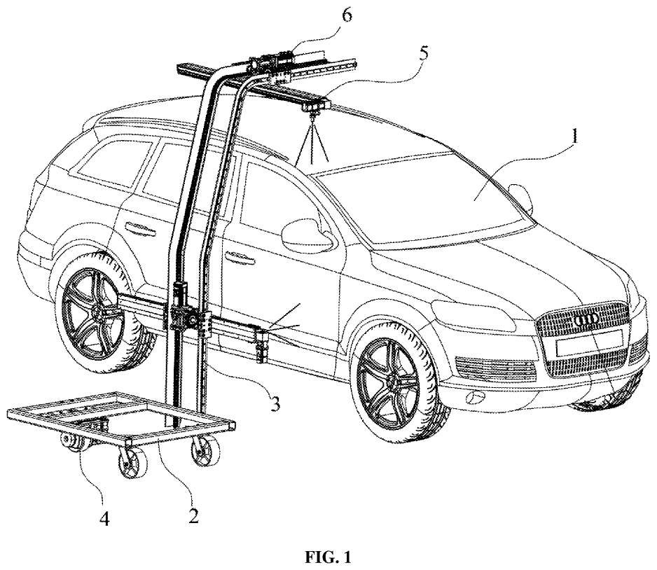

Based on the foregoing design and concept, this application further introduces the present disclosure in detail with reference to the FIG. 1 to FIG. 8 below.

An intelligent car washing robot, as shown in FIG. 1, configured to perform mobile line scanning cleaning on dirt 1 on a car to be washed in a three-axis linkage manner, including:
a main body 2, located on one side of a front passenger door of the car to be washed 1, and having a preset distance from the car to be washed 1, where the preset distance is a fixed safety distance preset between the main body 2 and the car to be washed 1 to prevent the main body 2 from being in contact with the car to be washed 1 during cleaning;
a traveling device 4, arranged on a bottom surface of the main body 2, detachably connected to the bottom surface of the main body 2, and configured to drive the main body 2 to travel from an initial position to one side of the front passenger door in an X-axis direction according to a preset route, where the X-axis direction is a forward direction of the traveling device;
a profiling arm 3, where one end of the profiling arm 3 is fixed to one side wall of the main body 2 and faces the car to be washed 1, the other end is located above the car to be washed 1, the traveling device 4 is configured to drive the main body 2 to clockwise move a circle around the car to be washed 1 from one side of the front passenger door in the X-axis direction, to drive the profiling arm 3 to move around the main body 2;
mobile devices 6, respectively arranged on an upper part and a lower part of the profiling arm 3, and in rolling connection to the profiling arm 3, where the mobile devices 6 are configured to respectively move reciprocally on the profiling arm 3 in a Y-axis direction and a Z-axis direction, the Y-axis direction is a vertical direction of the profiling arm relative to the car to be washed 1, and the Z-axis direction is a horizontal direction of the profiling arm 3 relative to the car to be washed 1; and
a cleaning device 5, located between the profiling arm 3 and the car to be washed 1, detachably connected to the mobile devices 6, and configured to follow movement of the mobile devices 6 to clean dirt at any position on the car to be washed 1 in a reciprocating line scanning manner.

After the traveling device 4 moves from the initial position to vicinity of the front passenger door of the car to be washed 1 in the Y-axis direction of the traveling device 4, first, following movement of the mobile devices 6 respectively in the Z-axis direction and the X-axis direction on the profiling arm 3, the cleaning device 5 performs, from one side of the front passenger door of the car to be washed 1, continuous scanning cleaning from bottom to top from a window on the front passenger door to a lower part of the front passenger door in the Z-axis direction, and simultaneously cleans the dirt on a car roof in the X-axis direction. Then, the traveling device 4 continues to drive the main body 2 to clockwise move a circle around the car body in the Y-axis according to the preset route, to drive the cleaning device 5 to gradually perform scanning washing around the car body. In an overall cleaning process, a three-axis linkage cleaning manner in the X-axis direction, the Y-axis direction, and the Z-axis direction is achieved, clean water can be completely sprayed to the whole body and tires and hubs of the car to be washed 1, and a problem of low car washing efficiency caused by incomplete cleaning at dead corners and uncleaned dirt in critical areas is directly avoided.

Specifically, as shown in FIG. 6 and FIG. 8, the main body 2 in this embodiment is provided with:
a control module 7, connected to and controls each of the cleaning device 5 and the traveling device 4, where selection of the control module 7 is to apply a control device with a control function to this field, for example, a steering control device for a three-fulcrum multi-direction forklift disclosed in Chinese patent application No. CN202020238746.7, which can achieve a purpose of controlling traveling in a straight line or steering; and
a server 8, where a data receiving end of the server 8 is in communication connection with a mobile terminal, and a data output end is in data connection with the control module 7. In a network environment, the server 8 is configured to receive request information and confirmation information sent by the mobile terminal. The control module 7 is configured to obtain the request information and the confirmation information, and output a control signal to the cleaning device 5 to control the cleaning device 5 to spray water to wash the car to be washed 1. The control module 7 is configured to send a straight signal or a steering signal to the traveling device 4 to control the traveling device 4 to travel in a straight line or to steer. The mobile terminal may be a mobile phone, a tablet computer, or any terminal device that can establish a communication network with the server 8. The mobile terminal may store a preset distance and a preset circling route through an application program. The surrounding route is a preset route that surrounds a car body and is preset in the mobile terminal according to different types of cars to be washed, and is applicable to any type of car to be washed 1 of trucks or passenger cars. Application software in this application is existing developed application software, as long as functions of this application can be realized, so an application range of the application software is not limited.

The server 8 obtains the request information and the confirmation information from the mobile terminal in the network environment, and transmits the request information to the control module 7. The control module 7 operates according to a preset program to obtain a control signal, and sends a signal to the cleaning device 5 to control the cleaning device 5 to move reciprocally on the profiling arm 3, to intelligently control the cleaning device 5 to clean the car to be washed 1. When it is determined that the intelligent car washing robot needs to move on one side of the car to be washed 1, the control module 7 sends a straight signal or a steering signal to the traveling device 4 to control the traveling device 4 to travel in a straight line or to steer, thereby moving a circle around the car to be washed 1. It is to be noted that the network environment in this application may be a communication network, such as a wireless local area network, a mobile data network, and Bluetooth, as long as transmission of data information between the server 8 and the mobile terminal can be implemented, and a network type is not limited.

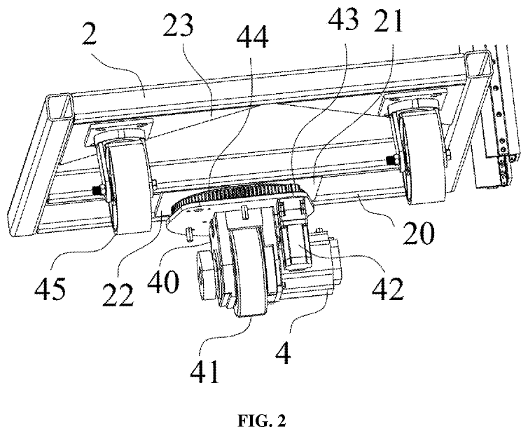

Specifically, as shown in FIG. 1 and FIG. 2, the main body 2 in this embodiment includes:
a support 20, mounted on a top surface of the traveling device 4, where one side wall of the support 20 is fixedly connected to the profiling arm 3, the support 20 is formed by welding a plurality of square steel tubes from end to end, and a square tube is further welded inside the support 20;
a first bottom plate 21, horizontally and fixedly connected to the support 20, where a surface of the first bottom plate 21 is welded to a bottom surface of the support 20, and the first bottom plate 21 is configured to carry the server 8;
a second bottom plate 22, opposite to a position of the first bottom plate 21, fixedly connected to the support 20, where, specifically, a surface of the second bottom plate 22 is welded to a bottom surface of the support 20, and the second bottom plate 22 is configured to carry the control module 7; and
a third bottom plate 23, horizontally and fixedly connected to an inner wall of the support 20, having a distance from both the first bottom plate 21 and the second bottom plate 22, where a shape of the third bottom plate 23 is a right-angled triangle, a right-angle side of the right-angled triangle is welded to the inner wall of the support 20, and the third bottom plate 23 is configured to carry a water tank. Specifically, the water tank may be placed or mounted on the third bottom plate 23. In this embodiment, only positions and a connection manner between the third bottom plate 23 and the water tank are illustrated. Although a specific mounting manner of the water tank is not illustrated, a function of the water tank 23 for carrying the water tank together with the support 20 is not affected.

A complete intelligent car washing structure is formed through the support 20, the first bottom plate 21, the second bottom plate 22, and the third bottom plate 23, which provides a necessary hardware carrying platform for intelligent car washing.

Specifically, as shown in FIG. 1 and FIG. 2, the traveling device 4 in this embodiment includes:
a base 40, located at a position below the first bottom plate 21 and the second bottom plate 22;
a power-driven wheel 41, arranged on one side of the base 40, rotatably connected to the base 40, and configured to change a movement direction through rotation;
a steering motor 42, detachably connected to the base 40, and on the same side of the power-driven wheel 41;
a steering driving wheel 43, arranged on the other side of the base 40, opposite to a position of the steering motor 42, located between the base 40 and the second bottom plate 22, and connected to a working end of the steering motor 42, where the steering motor 42 is configured to drive the driving wheel 43 to rotate relative to the base 40; and
a driven wheel 44, rotatably connected to the other side of the base 40, meshing the steering driving wheel 43, and located between the base 40 and the first bottom plate 21, where one side wall of the driven wheel 44 is connected to the power-driven wheel 41, and the other side wall is rotatably connected to a bottom surface of the main body 2, and specifically, is rotatably connected to the first bottom plate 21; the driving wheel 43 is configured to drive the driven wheel 44 to rotate between the first bottom plate 21 and the base 40 through rotation, and the driven wheel 44 is configured to drive the power-driven wheel 41 to rotate, thereby changing the movement direction of the main body 2.

In an embodiment, the traveling device 4 selects an Automatic Guided Vehicle (AGV) driving wheel. The AGV driving wheel has an automatic guide function, can travel to a parking area of the car to be washed 1 along a preset route, can move a circle around a car body according to a preset route, thereby driving the main body 2, the profiling arm 3, and the cleaning device 5 to achieve intelligent car washing, and having a characteristic of high degree of intelligence.

As shown in FIG. 1 and FIG. 2, taking a direction of the power-driven wheel 41 facing a rear of the car to be washed 1 as a straight-ahead direction, the power-driven wheel 41 moves straight ahead under the guide of the base 40. The steering motor 42 drives, after rotating, the driving wheel 43 to rotate. In a process that the driving wheel 43 rotates for a round, the driven wheel 44 is driven by the driving wheel 43 to rotate a preset arc, and the driven wheel 44 drives the power-driven wheel 41 to rotate a preset angle, so that the movement direction of the main body 2 is changed by changing a rotation direction to achieve a process of clockwise moving a circle around the car body from the front passenger door. The steering motor 42 selects a direct current servo motor, and a model is not limited.

Specifically, in this embodiment, a diameter of the driving wheel 43 is smaller than a diameter of the driven wheel 44, so that a rotating speed of the driven wheel 44 is lower than a rotating speed of the driving wheel 43, and finally, a purpose of changing the rotation direction of the main body 2 is achieved.

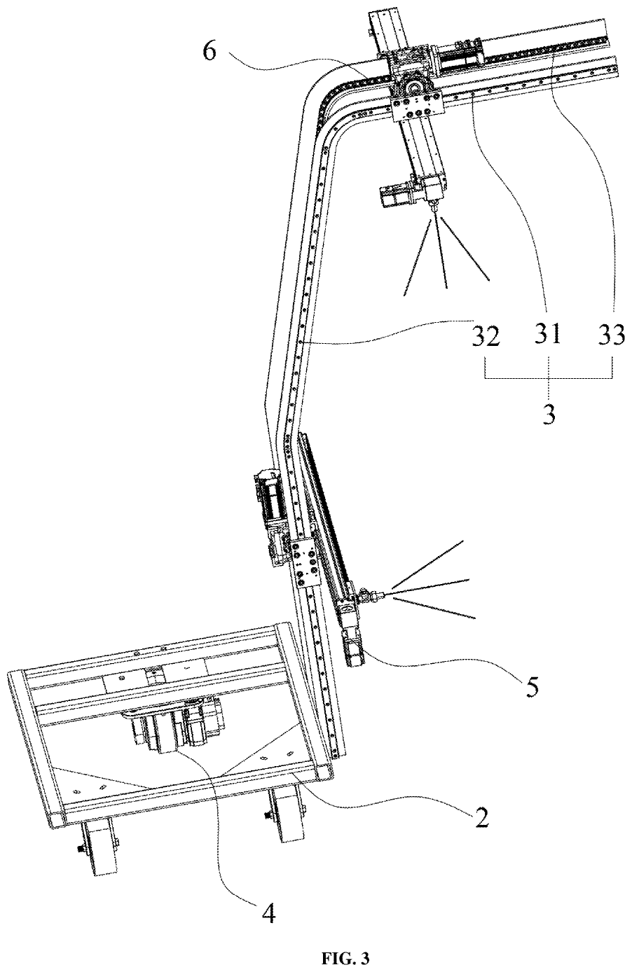

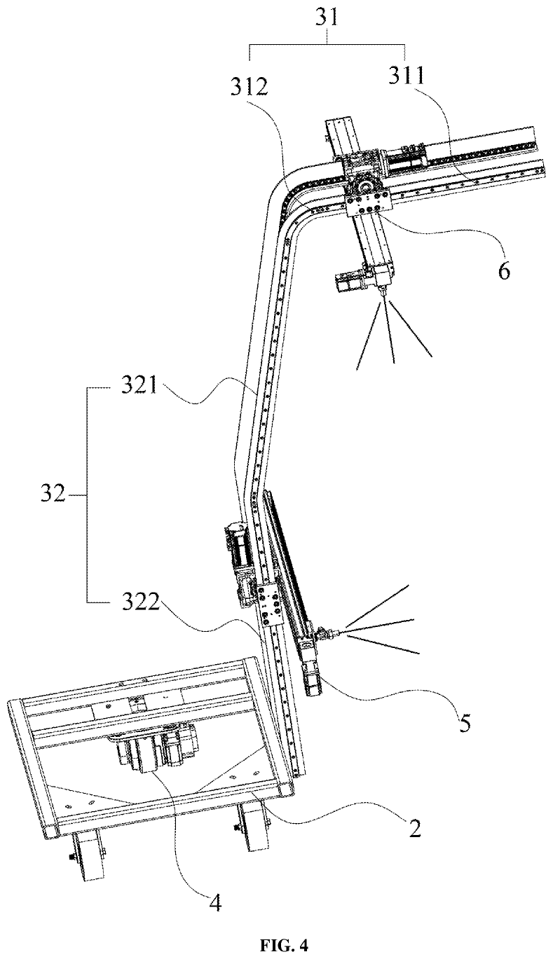

Specifically, as shown in FIG. 3 and FIG. 4, the profiling arm 3 in this embodiment includes:
an upper arm assembly 31, located at an upper horizontal position relative to the car to be washed 1, where a movement direction of the upper arm assembly 31 is an X-axis direction, and the upper arm assembly 31 is configured to cooperate with the cleaning device 5 to clean dirt on an upper surface of the car to be washed 1;
a lower arm assembly 32, located on a vertical side relative to the car to be washed 1, fixedly connected to the upper arm assembly 31, and configured to cooperate with the cleaning device 5 to clean the dirt on a side body of the car to be washed 1; and
track assemblies 33, respectively laid on the upper arm assembly 31 and the lower arm assembly 32, screwed to the upper arm assembly 31 and the lower arm assembly 32, and configured to carry the mobile devices, to enable the mobile devices 6 to move on the track assemblies 33.

During cleaning, the upper arm assembly 31 and the lower arm assembly separately 32 separately and simultaneously move on the track assemblies reciprocally, so that a side body of the car to be washed is cleaned through the lower arm assembly 32 while cleaning the upper surface of the car to be washed 1, and different areas of the car to be washed are cleaned simultaneously, thereby shortening cleaning time, and improving cleaning efficiency.

Specifically, as shown in FIG. 1, FIG. 3, and FIG. 4, the upper arm assembly 31 in this embodiment includes:
a cross arm 311, located above the car to be washed 1, and parallel to a top surface of the car to be washed 1; and
a bent arm 312, arranged at an end part of the cross arm 311, and fixedly connected to the cross arm 311. The mobile devices 6 are configured to move reciprocally between the cross arm 311 and the bent arm 312, so that the cleaning device 5 follows reciprocating movement of the mobile devices 6 to clean the top surface or an upper surface of the car to be washed 1.

The lower arm assembly 32 includes:
an inclined arm 321, where one end of the inclined arm 321 is fixedly connected to the other end of the bent arm 312, and is parallel to an upper body of the car to be washed 1; and
a vertical arm 322, where one end of the vertical arm 322 is fixedly connected to the other end of the inclined arm 312, and is parallel to a lower body of the car to be washed 1. When the cleaning device 5 follows the mobile devices 6 to move to the inclined arm 321, car windows, front windshield, and rear windshield are cleaned; and when the cleaning device 5 moves to the vertical arm 322, car doors, wheels, a rear bumper of the car, a front bumper of the car, and dirt at relatively low positions can be cleaned, thereby achieving a purpose of cleaning the whole car in a continuous scanning manner.

The bent arm 312 is to enable the cleaning device 5 to smoothly move to the inclined arm 321 from the cross arm 311. The bent arm 312 occupies ⅙ to ⅕ arc of a virtual circle where the bent arm 312 is located. An included angle between the inclined arm 321 and the vertical arm 322 ranges from 120° to 180°. Within this range, the inclined arm 321 and the vertical arm 322 will not be in contact with the car body, ensuring safety of the car to be washed 1 during cleaning.

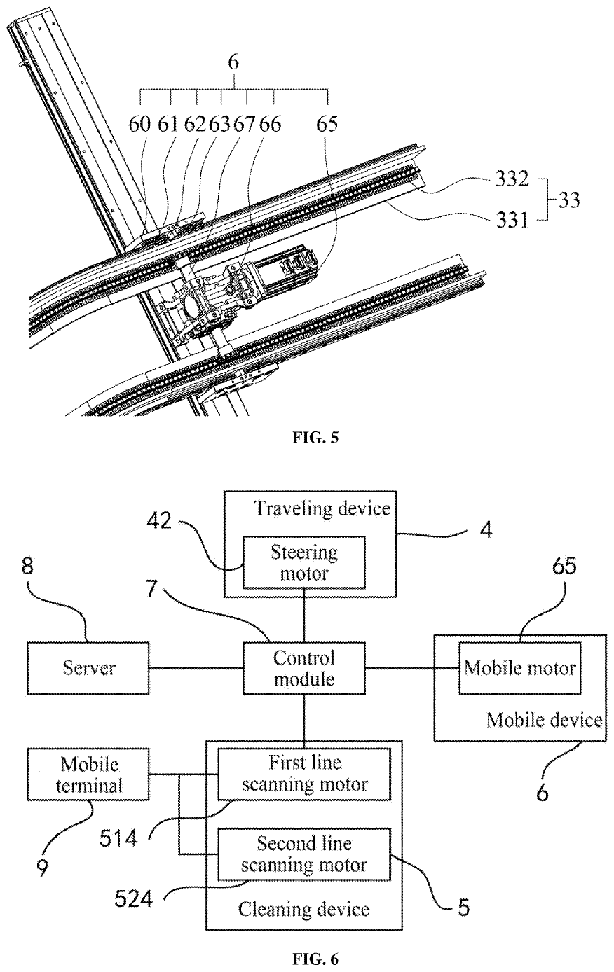

As shown in FIG. 3 and FIG. 5, the track assembly 33 includes:
chain slots 331, respectively provided in the cross arm 311, the bent arm 312, the inclined arm 321, and the vertical arm 322, and fitting the cross arm 311, the bent arm 312, the inclined arm 321, and the vertical arm 322; and
a chain 332, laid on the chain slots 331, where a bottom surface of the chain 331 is fixedly connected to the chain slots 331, a surface meshes the mobile devices 6, and the chain 332 is configured to cooperate with reciprocating movement of the mobile devices 6, so as to drive the cleaning device 5 to repeatedly clean the dirt on the car to be washed along the chain 332.

As shown in FIG. 1 and FIG. 5, the mobile device 6 includes:
a sliding plate 63, where one side wall of the sliding plate 63 is in contact with the profiling arm 3, the sliding plate 63 is configured to slide reciprocally on the profiling arm 3, and specifically, the sliding plate 63 is in contact with the cross arm 311, the bent arm 312, the inclined arm 321, and the vertical arm 322 sequentially during moving;
a first roller 61, fixed to one side wall of the sliding plate 63 through a fixing piece 62, in contact with an upper surface of the profiling arm 3, and configured to slide on an upper surface of the profiling arm 3;
a second roller 64, fixedly connected to the sliding plate 63, on the same side as the first roller 61, in contact with a lower surface of the profiling arm 3, and configured to move reciprocally along the lower surface of the profiling arm 3;
a mobile motor 65;
a transmission 66, connected to a working end of the mobile motor 65, where a bottom surface of the transmission 66 is screwed to the cleaning device 5; and
a rotating shaft 67, where a middle part of the rotating shaft 67 is connected to the transmission, an end part is rotatably connected to the profiling arm, and the transmission is configured to drive the rotating shaft 67 to move reciprocally on the cross arm 311, the bent arm 312, the inclined arm 321, and the vertical arm 322 of the profiling arm 3 by changing a rotation direction output by the mobile motor 65, to drive the cleaning device 5 to move along the profiling arm. Therefore, the mobile motor 65 indirectly drives the cleaning device 5 to move reciprocally on the profiling arm 3, so as to achieve a purpose of reciprocally cleaning the dirt on the car to be washed 1.

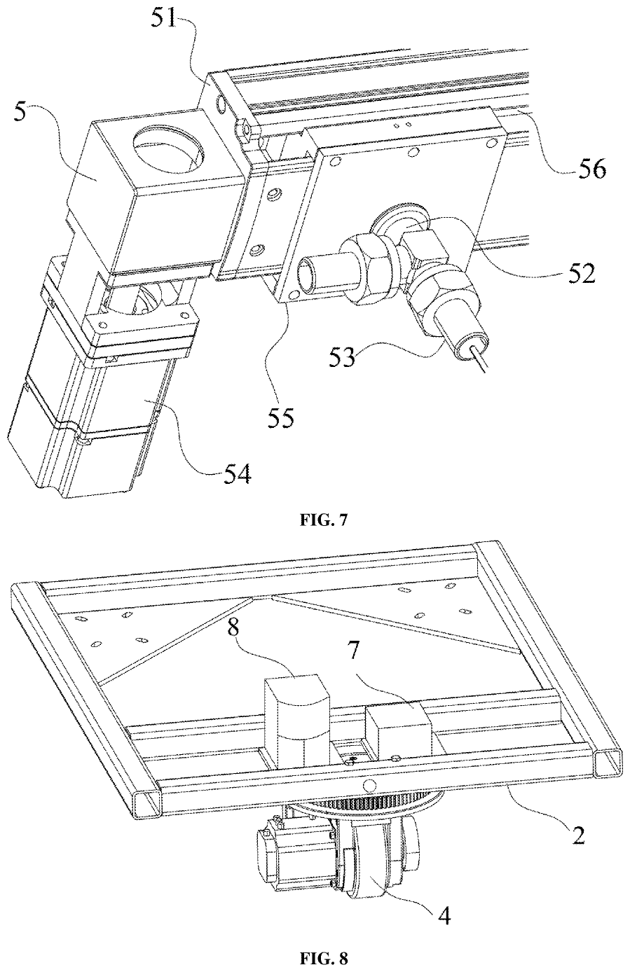

Specifically, as shown in FIG. 1 and FIG. 7, the cleaning device 5 in this embodiment includes:
a linear module 51, mounted on a bottom surface of the transmission 66 of the mobile device 6, and is configured to follow the transmission 66 to move reciprocally on an upper part and a lower part of the profiling arm 3;
a chute 56, provided in the linear module 51;
a sliding block 55, arranged on a bottom surface of the linear module 51, where a side wall of the sliding block 55 is in sliding connection with the chute 56;
a line scanning motor 54, mounted at an end part of the linear module 51, where a working end of the line scanning motor is connected to the sliding block 55, and is configured to drive the sliding block 55 to perform linear reciprocating movement in the chute 56;
a water spraying pipe 52, mounted outside the linear module 51, where an end part of the water spraying pipe 52 penetrates through the sliding block 55, and is configured to follow the sliding block 55 to move; and
a spray nozzle 53, screwed to the water spraying pipe 52, and configured to spray clean water in the water spraying pipe 52 to the car to be washed 1, to clean the dirt at any position of the car body of the car to be washed 1.

Pressurized clean water flow is sprayed, through the water spraying pipe 52, from the spray nozzle 53 to the car to be washed 1, and the linear module 51 follows the transmission 66 to move on the chain 332, so as to drive the water spraying pipe 52 to wash the car in a scanning manner, thereby achieving a purpose of thoroughly removing the dirt at any position of the car body.

Cleaning process:

With reference to FIG. 1 to FIG. 8, a cleaning process of the car to be washed 1 is described in detail by taking a fixed parking position of a robot as an initial position. Specific content is as follows:

A driver inputs request information through a mobile terminal. In a network environment, the server 8 obtains the request information transmitted by the mobile terminal, and transmits the request information to the steering motor 42 of the traveling device 4. The steering motor 42 automatically moves to one side of a front passenger door of the car to be washed 1 along a Y-axis direction according to a preset route based on the request information. After confirmation information is input on the mobile terminal, the server 8 obtains the confirmation information and transmits the confirmation information to the control module 7. The control module 7 reads the information and outputs a control signal to the cleaning device 5. The linear module 51 receives the control signal, and washes the car simultaneously on the chain 332 of the profiling arm 3 according to the preset route through the following two trajectories, which are specifically as follows:

A trajectory in the X-axis direction: the line scanning motor 54 drives the linear module 51 to move from the cross arm 311 to the bent arm 312 in the X-axis direction, and then returns from the bent arm 312 to the cross arm 311 to move. During this period, clean water is sprayed from the spray nozzle 53 through the water spraying pipe 52, is sprayed to a car roof, car windows, and glass of the car to be washed 1.

A trajectory in the Z-axis direction: the line scanning motor 54 drives the linear module 51 to move from a connection between the inclined arm 321 and the bent arm 312 to a lower end of the vertical arm 322 along the Z-axis direction, and then returns along an original route. During this period, clean water is sprayed to car windows, glass, and a front passenger door, and tires, so that the clean water may flush dirt on the car to be washed 1 from top to bottom, thereby saving the clean water.

The trajectory in the X-axis direction is actually that the clean water is gradually sprayed from the car roof to other parts of the car body, so that the clean water will gradually flow to the other parts of the car body along the car roof. When the car roof is mainly cleaned, the clean water can flush other areas to a certain degree in advance. When the clean water cleans other areas, the other areas will be cleaned more easily. Moreover, less clean water is used, so when the intelligent car washing robot washes the car round the car body, more water can be saved by the first movement trajectory, and the clean efficiency is higher.

When a cleaning of the front passenger door and corresponding car roof area is complete, the linear module 51 sends first feedback information to the control module 7, and the control module 7 receives the first feedback information and sends a straight signal to the steering motor 42 of the traveling device 4. The steering motor 42 moves to one side of a rear door behind a driver's door in the Y-axis direction according to a preset route, and the linear module 51 cleans according to the first movement route or the second movement route.

When a cleaning of the rear door behind the driver's door and corresponding car roof is completed, the linear module 51 sends second feedback information to the control module 7, and the control module 7 receives the second feedback information and sends a steering signal to the steering motor 42. The steering motor 42 works to drive the driving wheel 43 to rotate, so that the driving wheel 43 rotates to drive the driven wheel 44 to rotate to change a rotation direction of the power-driven wheel 41 to generate a rotation angle, thereby changing a movement direction of the main body 2. The main body 2 is moved to one side of a rear, and two linear modules 51 simultaneously clean the rear and a corresponding car roof area of the car to be washed 1 along the trajectory in the X-axis direction and the trajectory in the Z-axis direction respectively. By analogy, after the cleaning of a circle around the car to be washed 1 is completed, the traveling device 4 returns to the fixed parking position according to a preset route.

In conclusion, a car washing manner of the present disclosure is that after the traveling device 4 moves from an initial position to vicinity of the front passenger door of the car to be washed 1 in the Y-axis direction of the traveling device 4, the linear module 51 follows the rotating shaft 67 of the mobile device to move on the profiling arm 3 respectively in the Z-axis direction and the X-axis direction to perform, from one side of the front passenger door of the car to be washed 1, continuous scanning cleaning from bottom to top from a window on the front passenger door to a lower part of the front passenger door in the Z-axis direction, and meanwhile, to clean the dirt on the car roof in the X-axis direction. Then, the traveling device 4 continues to drive the main body 2 to move clockwise around the car body in the Y-axis according to the preset route, to drive the cleaning device 5 to gradually perform scanning washing around the car body. In an overall cleaning process, a three-axis linkage cleaning manner in the X-axis direction, the Y-axis direction, and the Z-axis direction is achieved, clean water can be completely sprayed to the whole body, tires, and hubs of the car to be washed 1, and a problem of low car washing efficiency caused by incomplete cleaning at dead corners and uncleaned dirt in critical areas is directly avoided.

This specific embodiment is merely an explanation of this application, but not a limitation to this application. Those skilled in the art can make modifications to the embodiment without creative contribution after reading this specification, which are protected by patent law as long as they are within the scope of claims of this application.

What is claimed is:

1. An intelligent car washing robot, configured to perform mobile line scanning cleaning on dirt on a car to be washed (1) in a three-axis linkage manner, wherein the intelligent car washing robot comprises: a main body (2), located on one side of a front passenger door of the car to be washed (1), and having a preset distance from the car to be washed (1); a traveling device (4), arranged on the main body (2), detachably connected to a bottom surface of the main body (2), and configured to drive the main body (2) to travel from an initial position to one side of the front passenger door in a Y-axis direction according to a preset route, wherein the Y-axis direction is a forward direction of the traveling device (4); a profiling arm (3), wherein one end of the profiling arm (3) is fixed to one side wall of the main body (2) and faces the car to be washed (1), the other end is located above the car to be washed (1), and the traveling device (4) is configured to drive the main body (2) to clockwise move a circle around the car to be washed (1) from one side of the front passenger door in the Y-axis direction, to drive the profiling arm (3) to move around the main body (2); mobile devices (6), respectively arranged on an upper part and a lower part of the profiling arm (3), and in rolling connection to the profiling arm (3), wherein the mobile devices (6) are configured to respectively move reciprocally on the profiling arm (3) in a Z-axis direction and an X-axis direction, the Z-axis direction is a vertical direction of the profiling arm (3) relative to the car to be washed (1), and the X-axis direction is a horizontal direction of the profiling arm (3) relative to the car to be washed (1); and a cleaning device (5), located between the profiling arm (3) and the car to be washed (1), detachably connected to the mobile devices (6), and configured to follow movement of the mobile devices (6) to clean dirt at any position on the car to be washed (1) in a reciprocating line scanning manner.

2. The intelligent car washing robot according to claim 1, wherein the main body (2) is provided with: a control module (7), which is connected to and controls each of the cleaning device (5) and the traveling device (4); and a server (8), wherein a data receiving end of the server (8) is in communication connection with a mobile terminal, a data output end is in data connection with the control module (7), a network environment, the server (8) is configured to receive request information and confirmation information sent by the mobile terminal, the control module (7) is configured to obtain the request information and the confirmation information, and output a control signal to the cleaning device (5) to control the cleaning device (5) to spray water to wash the car to be washed (1), and the control module (7) is configured to send a straight signal or a steering signal to the traveling device (4) to control the traveling device (4) to travel in a straight line or to steer.

3. The intelligent car washing robot according to claim 2, wherein the main body (2) comprises: a support (20), mounted on a top surface of the traveling device (4), wherein one side wall of the support is fixedly connected to the profiling arm (3); a first bottom plate (21), horizontally and fixedly connected to the support (20), and configured to carry the server (8); a second bottom plate (22), opposite to a position of the first bottom plate (21), fixedly connected to the support (20), and configured to carry the control module (7); and a third bottom plate (23), horizontally and fixedly connected to an inner wall of the support (20), having a distance from both the first bottom plate (21) and the second bottom plate (22), and configured to carry a water tank.

4. The intelligent car washing robot according to claim 1, wherein the traveling device (4) comprises: a base (40); a power drive wheel (41), arranged on one side of the base (40), rotatably connected to the base (40), and configured to change a movement direction through rotation of a perpendicular shaft of the base (40); a steering motor (42), detachably connected to the base (40), and on the same side of the power drive wheel (41); a steering driving wheel (43), arranged on the other side of the base (40), opposite to a position of the steering motor (42), and connected to a working end of the steering motor (42), wherein the steering motor (42) is configured to drive the driving wheel (43) to rotate; and a steering driven wheel (44), rotatably connected to the other side of the base (40), and meshing the driving wheel (43), wherein one side wall of the steering driven wheel (44) is connected to the power drive wheel (41), the other side wall is fixedly connected to a bottom surface of the main body (2) by bolts, and the driving wheel (43) and the steering driven wheel (44) mesh and rotate to drive the base (40) and the perpendicular shaft of the power drive wheel (41) to rotate, thereby changing the movement direction of the main body (2).

5. The intelligent car washing robot according to claim 1, wherein the profiling arm (3) comprises: an upper arm assembly (31), located at an upper horizontal position relative to the car to be washed (1), and configured to cooperate with the cleaning device (5) to clean dirt on an upper surface of the car to be washed (1); a lower arm assembly (32), located on a vertical side relative to the car to be washed (1), fixedly connected to the upper arm assembly (31), and configured to cooperate with the cleaning device (5) to clean the dirt on a side body of the car to be washed (1);
and track assemblies (33), respectively laid on the upper arm assembly (31) and the lower arm assembly (32), screwed to the upper arm assembly (31) and the lower arm assembly (32), and configured to carry the mobile devices (6), to enable the mobile devices (6) to move on the track assemblies (33).

6. The intelligent car washing robot according to claim 5, wherein the upper arm assembly (31) comprises: a cross arm (311), located above the car to be washed (1), and parallel to a top surface of the car to be washed (1); and a bent arm (312), arranged at an end part of the cross arm (311), and fixedly connected to the cross arm (311), wherein the mobile devices (6) are configured to move reciprocally between the cross arm (311) and the bent arm (312).

7. The intelligent car washing robot according to claim 6, wherein the lower arm assembly (32) comprises: an inclined arm, wherein one end of the inclined arm (321) is fixedly connected to the other end of the bent arm (312), and is parallel to an upper body of the car to be washed (1); and a vertical arm (322), wherein one end of the vertical arm (322) is fixedly connected to the other end of the inclined arm (321), and is parallel to a lower body of the car to be washed (1).

8. The intelligent car washing robot according to claim 7, wherein the track assembly (33) comprises chain slots (331), respectively provided in the cross arm (311), the bent arm (312), the inclined arm (321), and the vertical arm (322), and fitting the cross arm (311), the bent arm (312), the inclined arm (321), and the vertical arm (322); and a chain (332), laid on the chain slots (331), wherein a bottom surface of the chain (332) is fixedly connected to the chain slots (331), a surface meshes the mobile devices (6), and the chain (332) is configured to cooperate with reciprocating movement of the mobile devices (6).

9. The intelligent car washing robot according to claim 1, wherein the mobile device (6) comprises: a sliding plate (63), wherein one side wall of the sliding plate (63) is in contact with the profiling arm (3), and the sliding plate (63) is configured to slide reciprocally on the profiling arm (3); a first roller (61), fixed to one side wall of the sliding plate (63), in contact with an upper surface of the profiling arm (3), and configured to slide on an upper surface of the profiling arm (3); a second roller (64), fixedly connected to the sliding plate (63), on the same side as the first roller (61), in contact with a lower surface of the profiling arm (3), and configured to move reciprocally along the lower surface of the profiling arm (3); a mobile motor (65); a transmission (66), connected to a working end of the mobile motor (65), wherein a bottom surface of the transmission (66) is screwed to the cleaning device (5); and a rotating shaft (67), wherein a middle part of the rotating shaft (67) is connected to the transmission (66), an end part is rotatably connected to the profiling arm (3), and the transmission (66) is configured to drive the rotating shaft (67) to move reciprocally on the profiling arm (3) by changing a rotation direction output by the mobile motor (65), to drive the cleaning device (5) to move along the profiling arm (3).

10. The intelligent car washing robot according to claim 1, wherein the cleaning device (5) comprises: a linear module (51), mounted on the mobile device (6), configured to follow the mobile device (6) to move reciprocally on the upper part and the lower part of the profiling arm

(3) ; a chute (56), provided in the linear module (51); a sliding block (55), arranged on a bottom surface of the linear module (51), wherein a side wall of the sliding block (55) is in sliding connection with the chute (56); a line scanning motor (54), mounted at an end part of the linear module (51), wherein a working end of the line scanning motor (54) is connected to the sliding block (55), and is configured to drive the sliding block (55) to perform linear reciprocating movement in the chute (56); a water spraying pipe (52), mounted outside the linear module (51), wherein an end part of the water spraying pipe (52) penetrates through the sliding block (55), and is configured to follow the sliding block (55) to move; and a spray nozzle (53), screwed to the water spraying pipe (52), and configured to spray clean water in the water spraying pipe (52) to the car to be washed (1), to clean the dirt at any position of the car body of the car to be washed (1).
